(19) United States
(12) Patent Application Publication
(10) Pub. No.: US 2009/0104493 A1
(43) Pub. Date: Apr. 23, 2009

(54) Energy supply system of an aircraft

(76) Inventors: Dirk Metzler, Oberreute (DE); Matthias Ludwig, Lindenberg (DE); Ralf Cremer, Lindau (DE); Jacques Herzog, Simmerberg (DE); Georg Ried, Scheidegg (DE)

Correspondence Address: DILWORTH & BARRESE, LLP, 333 EARLE OVINGTON BLVD., SUITE 702, UNIONDALE, NY, 11553, US

(21) Appl. No.: 12/009,010

(22) Filed: Jan. 16, 2008

(30) Foreign Application Priority Data
Jan. 16, 2007 (DE) 102007002283.4
Apr. 16, 2007 (DE) 102007017820.6

(51) Int. Cl. H01M 8/04; H01M 8/00

(52) U.S. Cl. 429/26; 429/12

(57) ABSTRACT

The present invention relates to an energy supply system of an aircraft comprising a fuel cell and having one or more consumers which are or can be connected to the fuel cell such that they are supplied with energy directly or indirectly from the fuel cell in emergency operation as well has having at least one active energy store which is or can be connected to at least one of the consumers such that the consumer(s) is/are supplied with energy from the active energy store at least at times.

The present invention relates to an energy supply system of an aircraft comprising a fuel cell as well as comprising one or more consumers which are or can be connected to the fuel cell such that they are supplied with energy directly or indirectly from the fuel cell in emergency operation.

It is known from the prior art to use a RAM air turbine for the emergency energy supply whose shaft drives a hydraulic pump, whereby a sufficient hydraulic supply is ensured in emergency operation. It is also possible to drive a generator directly or indirectly via a hydraulic pump and a hydromotor by means of the RAM air turbine to ensure a sufficient emergency power supply.

It is furthermore known from the prior art to replace a RAM air turbine by a fuel cell system. Such a procedure is known from DE 10 2005 010 399 A1 in which the RAM air turbine is replaced by a fuel cell which is connected to a DC/DC converter and to a DC/AC converter via a power distribution unit. An electric motor pump is supplied via the DC/DC converter for the hydraulic supply. Electrical energy can be fed into the onboard network via the DC/AC converter. In the event of an undersupply of energy, the fuel cell system is automatically activated by the named power distribution unit.

The replacement of a RAM air turbine by a fuel cell is furthermore known from DE 198 21 952 C2. It can be seen from this reference that the DC current produced in the fuel cell is transformed into AC current by means of an inverter with the voltage system customarily used in the aircraft and then supplies a hydraulic pump and/or an onboard power system with energy.

On a failure or on a disturbance of the energy supply of an aircraft, there is a need to provide the emergency energy supply as quickly as possible to enable the emergency operation as seamlessly as possible. It is therefore the object of the present invention to further develop an energy supply system of the first named kind such that it works reliably and with a low start time.

This object is solved by an energy supply system having the features of claim 1. Provision is accordingly made for the energy supply system to have an active energy store which is or can be connected to at least one of the consumers such that the consumer(s) is/are supplied with energy from the active energy store at least at times. An essential feature of the present invention thus consists of the arrangement of an active energy store, by which an energy store is to be understood which is charged in the normal operation of the aircraft, i.e. is immediately available in case of need. It is possible in accordance with the invention in this manner to ensure an interruption-free power supply in emergency operation. The active energy store makes energy available for at least so long until the fuel cell has concluded its start phase and is thus likewise available for energy supply. The energy supply system of the present invention can thus supply the power outputs with “essential power”, that is the power supply for the components required in emergency operation such as onboard electronics, as well as “primary flight control power”, that is the hydraulic supply in emergency operation, also during the start phase of the fuel cell. An aircraft battery can thereby be dispensed with or made in smaller form.

The term “consumer” is to be given a wide interpretation and can include any component which requires an energy supply. One or more electric motors for the drive of a pump for the hydraulic supply or also components of the onboard electronics which have to be supplied with power in emergency operation can be examples.

The energy store can be connected to the normal energy supply such that it is charged by the normal energy supply and/or such that the energy store feeds energy into the normal energy supply as required.

This can also apply correspondingly to the connection between the energy store and the emergency power network. A unidirectional energy flow from or to the energy store or a bidirectional connection between the energy store and the emergency power network can also be present here. The energy store can thus also serve the network damping of the emergency power network.

In a preferred embodiment of the invention, provision is made for a converter, preferably a bidirectional converter, to be connected before the energy store, said converter preferably being connected to the normal energy supply of the aircraft and being charged via the energy store in normal operation of the aircraft. In this embodiment of the invention, the active energy store is preferably precharged by the energy supply of the aircraft via the converter in normal operation of the aircraft, preferably before the start or during the flight mission. The converter can, for example, be made as a DC/DC converter.

The demands of the interruption-free energy supply of the aircraft and the switching behavior of the fuel cell can be decoupled by the use of an active energy store in accordance with the invention. The advantage arises from this that both subsystems (energy store, fuel cell) can be operated at the respective optimum operating points. The high start time demand of a fuel cell (<1 second to nominal power) is considerably relaxed, which has a positive influence on the system design.

A further advantage of the invention consists of a continuous function test of the individual components largely being possible. The remaining components can be monitored by a suitable function test (BITE) without limiting the function of the emergency supply. This measure is of importance to enable the required computational reliability and to eliminate sleep times in the error calculation. Such an active monitoring is of advantage to achieve the reliability demands.

In a further embodiment of the invention, the energy supply system includes a bidirectional converter which is designed such that it enables an energy flow from the energy store or from another energy source to the normal energy supply of the aircraft. It is possible by the use of such a bidirectional converter to support the “normal supply”, that is the normal onboard energy supply of the aircraft by the energy store, or any other energy present in the emergency supply (e.g. flywheel masses). This can have further advantages at the aircraft level such as the saving of inverters or batteries.

A converter, preferably a bidirectional converter, can furthermore be provided which is designed such that it enables an energy flow from the energy store or from any other energy source to the emergency power supply of the aircraft and/or from the emergency power supply of the aircraft to the energy store or to any other energy source.

Provision is made in a further embodiment of the invention that the energy store is a supercapacitor.

In accordance with a further embodiment of the invention, the energy supply system includes a multiconverter containing power electric components of the elements of the energy supply system. The multiconverter can, for example, include all power electronic components of the architecture considered here for the emergency supply of the aircraft (DC/DC converter, step-up or step-down (optionally bidirectional)), energy store (supercapacitor), inverter for emergency power, etc. which can all be arranged together in a housing.

Provision can be made in this connection for the power electronic components to be designed as replaceable modules or as integrated assemblies. An optimization of the MTBF, reliability and in-service reliability can thereby be achieved. The same applies to the control components of the emergency supply considered here.

The modules can also be provided as integrated or decentralized units.

The fuel cell can be connected to the named multiconverter in a galvanic, electronic or magnetic manner.

In a further embodiment of the invention, at least one electric motor pump for the hydraulic supply is provided whose drive unit comprises at least two electric motors which are or can be connected to different energy sources. A further architecture variant is thus the concept of a “hybrid EMP” (EMP=electric motor pump) for the hydraulic supply. The drive unit of the pump consists of two independent electric motors which are supplied by different energy sources and drive a common hydraulic pump.

The coupling of the two drive systems can take place, for example, via a common motor shaft or via a differential transmission. A decoupling of the two drive strands to the largest extent is thus ensured, whereby the security risk of a direct electric coupling of both power supplies is eliminated.

It is conceivable that at least one of the electric motors is arranged such that it is supplied with energy from the normal onboard energy supply of the aircraft in the normal operation of the aircraft. It is furthermore conceivable that at least one of the electric motors is arranged such that it is actively supplied with energy from the fuel cell or from the active energy store in an emergency operation of the aircraft. If different types of motor (for example an AC motor which is fed directly by the aircraft network and a motor fed by an inverter and supplied with energy via the fuel cell or via the energy store) are used for the at least two electric motors, the EMP design is dissimilar, which has advantages for the error consideration.

As already stated above, a control device can be provided which controls the energy store such that it feeds in energy or supplies it to the consumers for at least so long until the fuel cell is available for the energy supply. In this case, the energy store thus takes over the energy supply for at least so long as the fuel cell is still in its start phase.

In accordance with the invention, a cooling system is further provided for the cooling of components of the aircraft or of the energy supply system. Provision is made in this connection that the fuel cell is or can be connected to this cooling system for the purpose of setting a suitable operating temperature of the fuel cell. In accordance with the invention, provision is thus made for the fuel cell system to co-use a part of a cooling circuit of another, preferably liquid-cooled system for its cooling for the purpose of limiting weight and complexity and to increase the reliability of the fuel cell system. Provision is preferably, but not necessarily made in this connection for this other system not to be used in case of emergency.

It is, for example, conceivable for the liquid cooling system for the cooling of e.g. electronic components, which are not used in emergency operation since they are not critical for a safe landing, to be used to cool the fuel cell. This requires that the same cooling medium can be used for both systems.

It is an advantage of this architecture that numerous components can be used together, such as cooling liquid pumps, heat exchangers, pipes, RAM air ducts and possibly also valves.

The heat exchanger can, for example, be a jointly used skin heat exchanger or also a jointly used heat exchanger integrated into a ram air duct.

Other systems have different disadvantages in respect to this. If, for example, a separate ram air duct is provided for the fuel cell emergency energy system in which a heat exchanger is arranged, an increased complexity and weight result as disadvantages since an additional ram air duct has to be provided at the aircraft as does the disadvantage of the lack of a possibility of monitoring the cooling system. If a heat exchanger with a blower is integrated inside the rump, the system waste heat is emitted to the air inside the rump. A disadvantage of this solution is found in the size of the heat exchanger and in the problem that the heat exchanger has to be operated in a closed environment, whereby an increase in air temperature within the rump can occur. Further disadvantages are a comparatively high weight and the lack of a possibility of monitoring the cooling system.

An advantage of the cooling system in accordance with the invention consists in the fact that the start time of the fuel cell can be reduced. Due to the liquid heated by the components (such as components of the electronics) to be cooled, the fuel cell stack is maintained at a specific temperature in the normal operation of the aircraft, which is advantageous for the start time of the system since the temperature of the fuel cell is decisive for its start time. This is made possible, for example in that a not fully closed valve or a not fully tightly closing valve is provided by means of which the fuel cell can be maintained at a specific temperature level via a suitable cooling medium.

A further advantage of the system consists of increased reliability. Since the pump, which can possibly be designed as redundant and parallel, and the heat exchangers are operated in normal operation of the aircraft, the uncertainty of the dormancies for the shared components, that is for the jointly used components, is not relevant.

A further advantage consists of the lower weight since numerous components, as stated, can be used both for the cooling of the other components and for that of the fuel cell stack and can thus operate two systems.

Further details and advantages of the invention will be explained in more detail with reference to an embodiment shown in the drawing. There are shown:

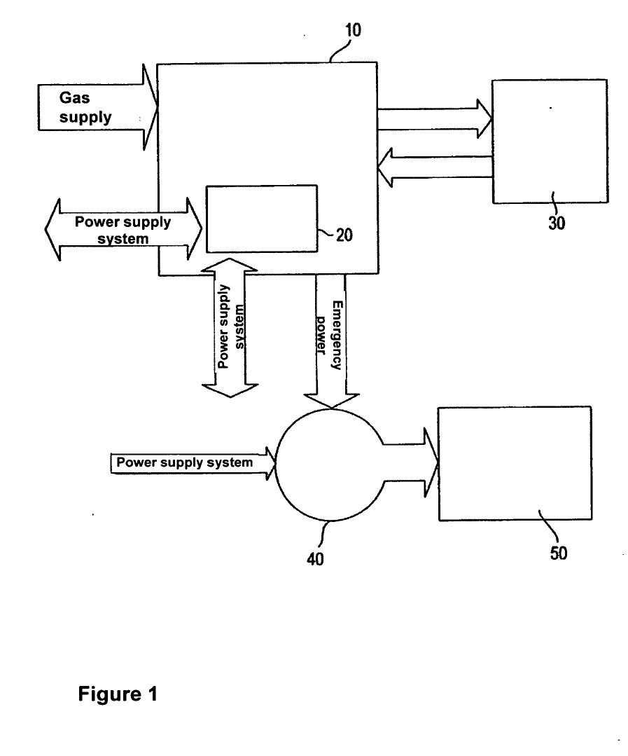

FIG. 1: a schematic representation of the fuel cell based emergency power system in accordance with the invention;

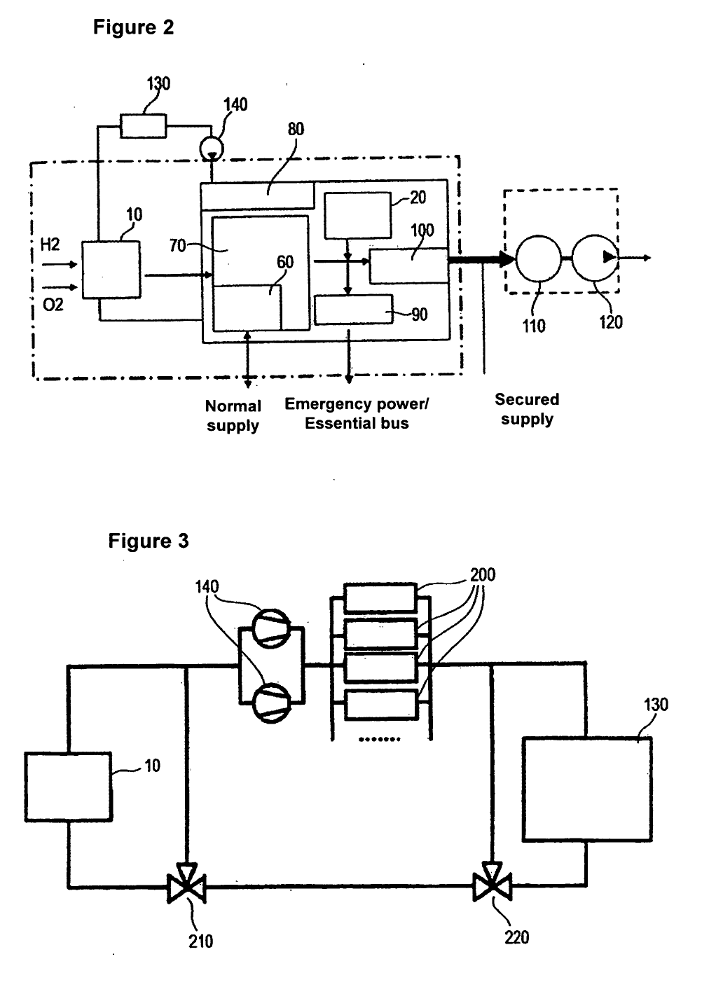

FIG. 2: a further schematic representation of the fuel cell based emergency power system in accordance with the invention;

FIG. 3: a schematic representation of the cooling system of the energy supply system in accordance with the invention; and

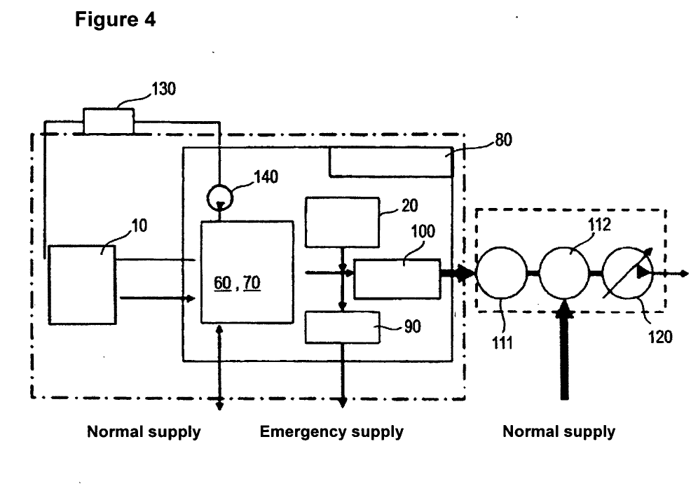

FIG. 4: a schematic representation of the energy supply system in accordance with the invention with a hybrid EMP.

FIG. 1 shows, by the reference numeral 10, a fuel cell system which has a fuel cell, on the one hand, and an active energy store 20, on the other hand. The gas supply shown in FIG. 1 serves the operation of the fuel cell. The power supply system shown serves to charge the energy store 20 and/or to maintain it in the charged condition before and during a flight via the normal onboard network supply (“power supply system”). As can further be seen from FIG. 1, the energy store 20 can also be used to feed energy into the power supply system or to cope with an increased energy requirement. The connection is thus bidirectional.

In normal operation of the aircraft, the energy store 20 thus serves as a buffer of the onboard power supply system.

An external heat exchanger is marked by the reference numeral 30 which can be designed, for example, as a ram air duct heat exchanger or also as a skin heat exchanger and which serves inter alia for the temperature control of the fuel cells.

In the case of a disturbance or of a failure of the power supply system, an interruption-free power supply is ensured in that the energy store 20 takes over the power supply and indeed for at least as long until the fuel cell works after its start phase in an operating state in which it can ensure the required energy supply.

The connection between the energy store 20 and the emergency power supply system is likewise bidirectional. The energy store 20 can also be used for network damping for the emergency power supply system.

Within the framework of the present invention, a control unit or a switching unit can be used which, as required, connects the fuel cell to the consumers to be supplied or ensures their energy supply through the energy store and the fuel cell. In this connection, the control unit or the switching unit are preferably designed such that an interruption-free energy supply is ensured.

A redundant motor drive can furthermore be seen from FIG. 1 with the reference numeral 40 which consists of two electric motors which are seated on a common shaft or which drive the pump 50 via a differential transmission. As can be seen from FIG. 1, one of the electric motors is fed via emergency power which is made available by the energy store 20 or the fuel cell and another motor via the onboard power supply system in use in normal operation of the aircraft.

The double arrows in FIG. 1 characterize the bidirectional connection of the energy store 20 to the respective power supply system.

FIG. 2 shows, in a detailed representation, the fuel cell based emergency power system for aircraft in accordance with the present invention.

As can be seen in detail from FIG. 2, the fuel cell 10 is supplied with hydrogen and oxygen and supplies DC current as required.

An energy store is shown by the reference numeral 20 which is designed as a supercapacitor and which is charged via a converter 60, 70 before a flight mission via the normal power supply of the aircraft. The converter 60, 70 is bidirectional so that the energy made available by the energy store 20 can also be fed into the normal power supply system, for instance to support the power supply system on a particular high power requirement. The energy store 20 in this case represents a buffer for the normal onboard power supply system of the aircraft.

A converter, designed as a DC/DC converter, for example, is marked by the reference numeral 70 and converts the DC current made available by the fuel cell 10 in a suitable manner.

The reference numeral 80 characterizes a multiconverter in which the power electronic components of the elements shown of the energy supply system are combined.

The inverter 90 is likewise designed bidirectionally and serves the making available of the desired current/voltage characteristic for the emergency power supply (“emergency power/essential bus”) of consumers such as for the supply of instruments in emergency operation, and the inverter 100 serves the making available of a suitable current/voltage supply for a further consumer which, in accordance with FIG. 2 is formed by the motor 110 of an electronic motor pump (EMP) 120. The energy store can also be used via the converter 90 for network damping for the emergency power supply system.

The inverter 90, 100 is preferably an inverter with step-up.

A heat exchanger is shown by the reference numeral 130 and a pump of a coolant circuit is shown by the reference numeral 140.

In normal operation of the aircraft, the energy store 20 is charged by the normal onboard energy supply of the aircraft via the bidirectional converter 60 so that the energy store 20 is already in the charged state, that is the active state, at the start of the flight mission.

If the normal energy supply fails or if it is disturbed, as is the case, for example, when the onboard power network voltage falls under a limit value, an interruption-free power supply is made available in that the active energy store 20 provides power to the power outputs “emergency power/essential bus” shown here and to the further consumers (“primary flight control power”) until the fuel cell 10 is in its operating state after the end of the start process. As soon as the fuel cell has concluded its start phase, it takes over the further emergency power supply.

The emergency energy supply of the outputs emergency power/essential bus or of the further consumers such as an electric motor takes place via the inverters 90, 100 which make available the desired voltage/current characteristics as required.

A cooling system is shown in FIG. 2 which serves the cooling of the electronic components of the system shown. The preferably liquid coolant is heated due to the cooling of the electronic components and then flows through the fuel cell stack 10, whereby the latter can be maintained at a suitable temperature. A skin heat exchanger or also a heat exchanger integrated into a ram air duct can, for example, be considered as the heat exchanger 130 of the cooling system.

FIG. 3 shows such an arrangement of a cooling system, with different components to be cooled such as electronic components or also other components of the aircraft or of the energy supply system being shown by the reference numeral 200. Two pumps arranged in parallel and serving the pumping of the cooling medium are shown by the reference numeral 140.

Reference numeral 130 characterizes the heat exchanger which serves the cooling of the liquid cooling medium. It can—as stated—e.g. be a skin heat exchanger or a heat exchanger integrated into a ram air duct.

As can furthermore be seen from FIG. 3, the fuel cell does not have its own cooling system, but is connected to the named cooling system of the components 200. In normal operation, for example, it can be ensured by a not fully tightly closing valve 210 that the cooling liquid heated by the cooling of the components 200 is utilized to maintain the fuel cell stack 10 at a specific temperature. The valve 210 shown in FIG. 3 serves this purpose. The valve 220 serves to control the portion of the coolant flow which should be cooled in the heat exchanger 130.

FIG. 4 finally shows an architectural variant of the energy supply system in accordance with the invention with a hybrid EMP. Components which are the same or functionally the same are provided with the same reference numerals as in FIG. 2. As can be seen from FIG. 4, the drive unit of the pump 120 consists of two electric motors 111, 112 of which one (111) is supplied with energy via an inverter 100 by the energy store 20 or the fuel cell 10 in emergency operation and wherein the other of the motors 112 is supply via the onboard energy supply of the aircraft. An advantage of this arrangement consists of the fact that the two drive trains are largely decoupled and that, for example, different motor types can be used so that the motor design is dissimilar, which brings along advantages for the error consideration.

An interruption-free power supply of the power outputs of the system can be realized by means of the energy supply system in accordance with the invention and higher order synergies can thus be achieved at aircraft level (weight savings due to reduction of or dispensing with the batteries). The energy store in accordance with the invention is operated as an active element.

To satisfy a suitable monitoring concept and the reliability demands, the power electronics can be operated actively in a BITE mode. This can—as stated—preferably be realized in that a converter, designed as a DC/DC converter, for example, is operated and the required energy is stored in a supercapacitor. The output side power modules are monitored at the end of the flight mission on the discharging of the supercapacitor.

The use of a preferably additional bidirectional converter, designed as a DC/DC converter, for example, further increases the function of the system also to buffer the normal power supply apparatus with energy via the active energy store or supercapacitor. Further synergy effects can hereby be achieved at aircraft level.

The concept described of a hybrid EM is dissimilar in approach and eliminates the problem of the coupling of the two power supply paths, which brings along safety advantages.

1. An energy supply system of an aircraft comprising at least one fuel cell, having one or more consumers which are or can be connected to the fuel cell such that they are supplied with energy directly or indirectly from the fuel cell in emergency operation as well has having at least one active energy store which is or can be connected to at least one of the consumers such that the consumer(s) is/are supplied with energy from the active energy store at least at times.

2. An energy supply system in accordance with claim 1, wherein a converter connected before the energy store, preferably a bidirectional converter, is provided which is connected to the normal energy supply of the aircraft and is charged via the energy store in normal operation of the aircraft before and/or after during a flight.

3. An energy supply system in accordance claim 1, wherein a converter, preferably a bidirectional converter, is provided which is designed such that it enables an energy flow from the energy store or from any other energy source to the normal energy supply of the aircraft.

4. An energy supply system in accordance with claim 1, wherein a converter, preferably a bidirectional converter, is provided which is designed such that it enables an energy flow from the energy store or from any other energy source to the emergency power supply of the aircraft and/or from the emergency power supply of the aircraft to the energy store or to any other energy source.

5. An energy supply system in accordance with claim 1, wherein the energy store is a supercapacitor.

6. An energy supply system in accordance with claim 1, wherein the energy supply system furthermore comprises a multiconverter which contains power electronic components of the energy supply system.

7. An energy supply system in accordance with claim 6, wherein the power electronic components are designed as replaceable modules or as integrated assemblies.

8. An energy supply system in accordance with claim 1, wherein at least one electric motor pump is provided for the hydraulic supply and a drive unit is provided for the drive of the motor pump, with the drive unit including at least two electric motors which are or can be connected to different energy sources.

9. An energy supply system in accordance with claim 8, wherein the at least two electric motors drive the pump via a common motor shaft or via a differential transmission.

10. An energy supply system in accordance with claim 8, wherein at least one of the electric motors is made such that it is supplied with energy by the normal energy supply of the aircraft in normal operation of the aircraft.

11. An energy supply system in accordance with claim 8, wherein at least one of the electric motors is designed such that it is supplied with energy by the fuel cell or the active energy store in emergency operation of the aircraft.

12. An energy supply system in accordance with claim 8, wherein the drive unit of the pump has at least two electric motors of different types.

13. An energy supply system in accordance with claim 1, wherein a control device is provided which controls the energy store such that it supplies energy for at least so long until the fuel cell is available for the energy supply.

14. An energy supply system wherein a cooling system is provided for the cooling of components of the aircraft or of the energy supply system; and the fuel cell is or can be connected to this cooling system for the purpose of setting a suitable operating temperature of the fuel cell.

15. An energy supply system in accordance with claim 14, wherein the cooling system is a cooling system for the cooling of electronic components.

16. An energy supply system in accordance with claim 14, wherein the cooling system has at least one heat exchanger which is a ram air duct heat exchanger or a skin heat exchanger.

17. An energy supply system in accordance with claim 1, wherein a cooling system is provided for the cooling of components of the aircraft or of the energy supply system; and the fuel cell is or can be connected to this cooling system for the purpose of setting a suitable operating temperature of the fuel cell.

18. An energy supply system in accordance claim 2, wherein a converter, preferably a bidirectional converter, is provided which is designed such that it enables an energy flow from the energy store or from any other energy source to the normal energy supply of the aircraft.

19. An energy supply system in accordance with claim 18, wherein a converter, preferably a bidirectional converter, is provided which is designed such that it enables an energy flow from the energy store or from any other energy source.

20. An energy supply system in accordance with claim 2, wherein a converter, preferably a bidirectional converter, is provided which is designed such that it enables an energy flow from the energy store or from any other energy source.
